(19) United States
(12) Patent Application Publication
(10) Pub. No.: US 2009/0248392 A1
(43) Pub. Date: Oct. 1, 2009

(54) FACILITATING LANGUAGE LEARNING DURING INSTANT MESSAGING SESSIONS THROUGH SIMULTANEOUS PRESENTATION OF AN ORIGINAL INSTANT MESSAGE AND A TRANSLATED VERSION

(75) Inventors: SMRITI TALWAR, CLONSILLA (IE); KRISTINA BECKLEY, CARLISLE, MA (US); YAO PANG SONG, CARY, NC (US)

Correspondence Address: PATENTS ON DEMAND, P.A. - IBM CAM, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/054,928

(22) Filed: Mar. 25, 2008

(51) Int. Cl. G06F 17/28

(52) U.S. Cl. 704/3

(57) ABSTRACT

An instant messaging (IM) interface, system, and method, where the interface includes a dialog region and a communication entry region. The interface can optionally be an interface of a social networking Web site or application. The dialog region is configured to present a running IM dialog that includes content exchanged in real-time between a set of IM communicators. The dialog region is configured such that at least a portion of the content from IM communicators presented in the dialog region is presented in an original language in which it was entered and is also presented in a translated form in a different language specified by settings specific to the user of the IM interface. The communication entry region is configured to permit content to be input that is to be conveyed to each of the IM communicators participating in an IM communication session involving the user of the IM interface.

### BACKGROUND OF THE INVENTION

The present invention relates to the field of instant messaging software and language tools and, more particularly, to facilitating language learning in instant messaging through simultaneous presentation of the original instant message and a foreign language translation in a social network.

Instant messaging has been quickly adopted as a convenient and effective means to establish and maintain personal and business relationships. As a key component of many social networking infrastructures, instant messaging has become ubiquitous and is used heavily by a vast majority of users. Often times, instant messaging is used to communicate with others who speak foreign languages. One solution that is employed to bridge the language gap is the use of language tools to perform translations. These translation tools, however, fall short when users employ slang, colloquialisms, and idiomatic expressions. For example, a common English greeting “what's up?” does not correctly translate into other languages; nor does IM shorthand like “brb” translate well. As such, language tools can often fail to translate expressions resulting in unintelligible instant messages or worse distort the user's statements through inaccurate translation.

These existing language tools fail to take advantage of a fact that one or more of the communicators may possess some proficiency in the original and in the translated language. That is, a possibly bilingual IM communicator is presented with only the translation or only the original versions of IM content, which negates any potential translation-problem mitigation actions that could be performed by a human with some language proficiency. That is, if both the original and the translated versions were presented (which is not the case for conventional IM applications) a reader could often infer a proper meaning by looking at the original language, whenever an automated mistranslation occurs.

Further, users interested in learning a new language are hindered by current instant message translation technology. Current translation features do not provide a means for the user to learn the language being translated. User's miss opportunities to obtain “real world” practice during instant message sessions as translation is transparently and automatically performed. In other words, users are not part of an interactive learning process which can aid in learning a foreign language.

### BRIEF SUMMARY OF THE INVENTION

One aspect of the present invention discloses a method, a computer program product, a system, and an apparatus for dynamically translating Instant Messaging (IM) communications. The aspect can identify IM content that was entered into an IM interface in a first language. The IM content can be automatically translated to a second language. The translated IM content in the second language and the originally entered IM content in the first language can both be presenting within an IM interface.

Another aspect of the present invention comprises an IM system that includes an IM server configured to facilitate IM communications involving a set of IM users. The IM server can include a presence component and a translation service component. The presence component can provide presence information regarding the IM users for presentation in a contact list of client-side IM applications. The translation service component can receive IM content in a first language, can translate the received IM component to a second language in accordance with recipient established settings, and can convey the received IM content in the first language and the translated IM content in the second language to a remotely located client of a recipient who established the translation settings.

Still another aspect of the present invention comprises an instant messaging (IM) interface that includes a dialog region and a communication entry region. The dialog region is configured to present a running IM dialog that includes content exchanged in real-time between a set of IM communicators. The dialog region is configured such that at least a portion of the content from IM communicators presented in the dialog region is presented in an original language in which it was entered and is also presented in a translated form in a different language specified by settings specific to the user of the IM interface. The communication entry region is configured to permit content to be input that is to be conveyed to each of the IM communicators participating in an IM communication session involving the user of the IM interface.

### BRIEF DESCRIPTION OF THE SEVERAL VIEWS OF THE DRAWINGS

FIG. 1 is a schematic diagram illustrating a system for facilitating language learning in instant messaging through simultaneous presentation of the original instant message and a foreign language translation in accordance with an embodiment of the inventive arrangements disclosed herein.

FIG. 2 is a schematic diagram illustrating an instant messaging interface with language learning capabilities in accordance with an embodiment of the inventive arrangements disclosed herein.

FIG. 3 is a schematic diagram illustrating an interface for configuring language settings of an interface which can assist a user in learning a language in accordance with an embodiment of the inventive arrangements disclosed herein.

FIG. 4 is a schematic diagram illustrating a method for simultaneously presenting a user with an instant message and a corresponding translation into another language in accordance with an embodiment of the inventive arrangements disclosed herein

### DETAILED DESCRIPTION OF THE INVENTION

The present invention discloses a solution for facilitating language learning during instant messaging sessions through simultaneous presentation of an original instant message and a translated version. In the solution, an instant messaging interface can concurrently present instant messages and a translation of the message based on a user selected language. The interface can permit users to transparently communicate in different languages during instant message conversations. The solution can facilitate a learning process by presenting language specific learning tools and translations via text, audio, and/or video. The solution can be configured to function in tutor mode which can engage the user in language exercises, such as conversational sessions. User presence information, language preference, language competency/skill level, and the like can be communicated between instant message clients to allow users to find appropriate language partners and increase their social network in the process.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

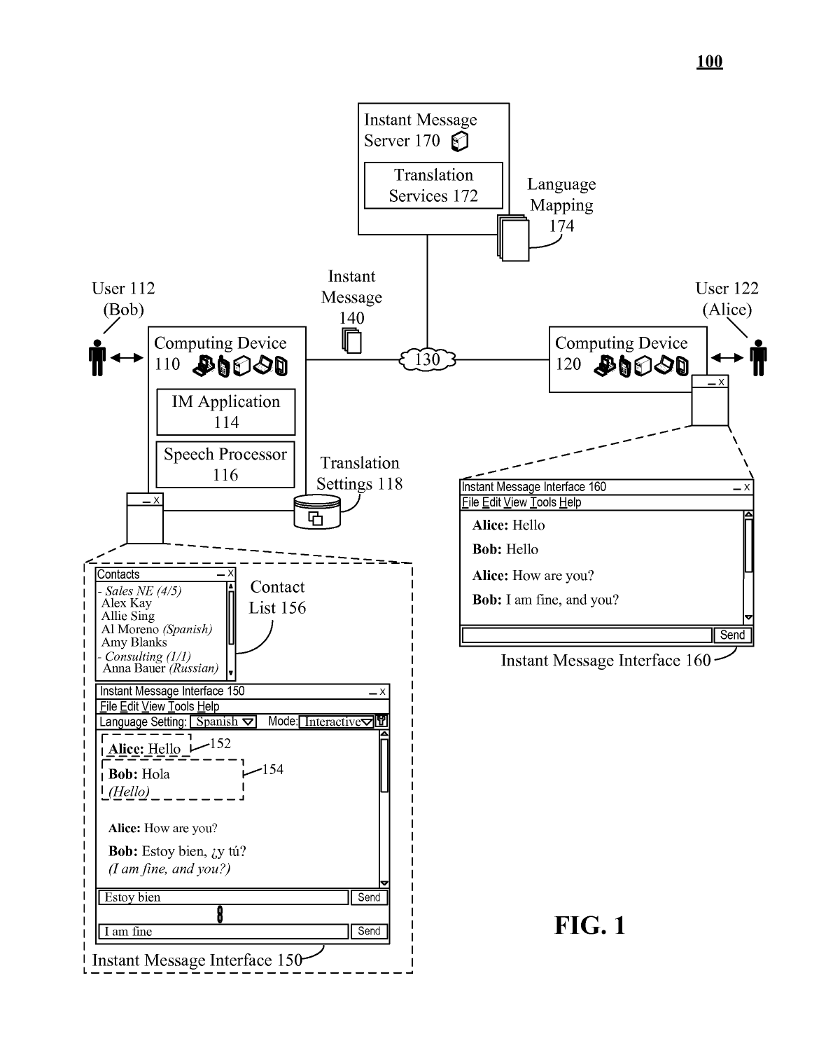

FIG. 1 is a schematic diagram illustrating a system 100 for facilitating language learning in instant messaging (IM) through simultaneous presentation of the original IM message and a foreign language translation in accordance with an embodiment of the inventive arrangements disclosed herein. In system 100, user 112 can practice and/or learn a language during an instant message communication session with user 122. Computing device 110 equipped with an IM Application 114 can permit user 112 to use a foreign language when communicating with user 122 via instant message. Services 172 can be used to dynamically translate instant message 140 for presentation based on user specific translation settings 118.

As used herein, languages can include natural languages, mixed languages, region specific dialects, sign language, Braille, constructed languages, and the like. For example, languages can include English, German, Spanish, French, Urdu, Chinese, and the like. The language translations can be into a different character set (e.g., from English characters to Arabic characters) and/or into a phonetic representation based on a single character set. Translations can be textual translations and/or audible translations. Additionally, language mapping 174 data can be utilized to provide translations for instant message sessions.

Instant messaging can include, but is not limited to, any real time exchange of digital content, including text, video, graphics, data, audio, and the like. Instant messaging is used generically to include any number of communication protocols, such as an instant messaging protocol, an electronic chat protocol, text messaging protocols, short message service (SMS) based protocols, video teleconferencing protocols, and the like.

IM application 114 can comprise of contact list 156 and instant message interface 150. Contact list 156 can be used to locate a user (e.g. Alice) with an interest in a specific language. In one embodiment, the contact list 156 can be associated with a social networking site or application. Thus, a social networking circle of individuals desiring to communicate in various languages to improve their individual language skills can be established. Once an appropriate user is selected, interface 150 can be presented to user 112 to start an instant message session. Interface 150 can simultaneously present a user entered instant message and a translated version 154 to user 112, assisting user 112 in learning a language. User 112 can choose to send the original inputted instant message or a translated version of the instant message to user 122. Based on translation settings 118 established by user 112, instant message 140 can be transmitted to user 122. For example, Bob (user 112) can send the instant message 154 “hola” to Alice (user 122), which can be translated by server 170 and presented to Alice as “hello”.

Instant messages 140 sent via network 130 from user 112 to user 122 can be translated by services 172 prior to transmission. Alternatively, message 140 can be transmitted without translation. Based on configuration settings of interface 160, translation of message 140 can be performed by services 172. Alternatively, translation of instant messages can be performed locally by language functionality present in IM application 114 (e.g. foreign language plug-in).

In one embodiment, interface 150 can be a voice enabled interface (VUI) or a multimodal interface capable of speech processing functions, such as speech recognition and speech generation functions. Speech processor 116 can be used to process user speech input and/or present translations to the user 112. Further, speech processor 116 can be utilized during language pronunciation exercises to verify users correctly enunciate words. By matching user utterances with pronunciation information, processor 116 can alert users of correct and incorrect articulation. The speech processor 116 is an optional component and the invention can be implemented in a GUI interface 150, in a text interface 150, or in another interface 150 that is not speech-enabled.

Instant message server 170 can be a hardware/software computing device able to send and receive instant messages from one or more instant messaging clients. Server 170 an include translation services 172 and language mapping 174. Services 172 can include a Web service, application service, and the like. Mapping 174 can include language information stored in a relational fashion used to translate from one source language to another target language.

Computing devices 110, 120 can be a hardware/software entity capable of performing instant messaging capabilities over one or more networks 130. Devices 110, 120 can include, but is not limited, to desktop computer, laptop, mobile phone, portable multimedia device, portable internet device, and the like.

It should be emphasized that one contemplated implementation for the enhanced language capabilities of system 100 is in a social networking context. Social networking refers to any information technology based system facilitating an establishment and an interaction between a community of people who share interests, activities, or who are interesting in exploring new interests or activities. One of those interests can be in learning a new language, which is facilitated by the language enhancement disclosed herein. The language learning aspect need not be a primary concern for a given social interaction within a social networking context, but can be an ancillary benefit. For example, a primarily English speaking social network participant can be interesting in one or more facets of Japanese culture, which they can explore with Japanese speaking social networking members, who may optionally have some interest in learning about American culture and/or language. In another example, a business person engaging in increasing business activity with a Saudi Arabian counterpart can utilize the language enhancements disclosed herein during IM communications to help prepare them for face-to-face interactions or for trips to the Saudi Arabia or other Arabic speaking country.

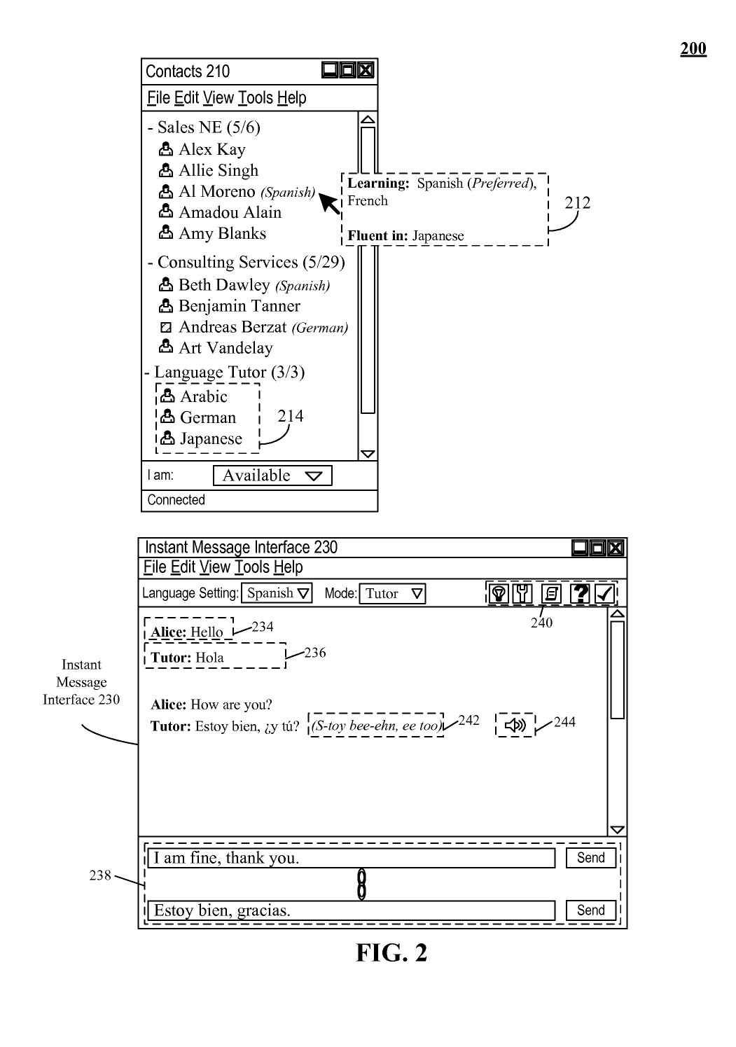

FIG. 2 is a schematic diagram illustrating an instant messaging interface 200 with language learning capabilities in accordance with an embodiment of the inventive arrangements disclosed herein. Interface 200 can be presented in the context of system 100. Interface 200 can include, but is not limited to, a contacts list interface 210 and an instant messaging interface 230. Interface 200 can be utilized to locate users with similar language interests and communicate with users in one or more languages. Although interface 200 (including interfaces 210 and 230) shows a graphical user interface (GUI) other implementations, such as a voice user interface (VUI), a multimodal interface, and the like, are contemplated. Further, derivatives of the interface elements, which are presented for illustrative purposes, are contemplated.

As shown, contacts interface 210 can maintain and present a list of contacts in a social network that are available for instant message sessions. Contacts 210 can include users interested in learning another language and/or users capable of help other users learn a language. Tooltip 212 can be used in identifying users with the propensity towards communicating in specific languages. In one embodiment, tooltip 212 can present a list of one or more languages a contact prefers to learn. Further, tooltip 212 can present a list of one or more languages a contact has proficiency with. Alternatively, tooltip 212 information can be viewed from a profile information interface.

In one embodiment, language preference information can be used to automatically match users based on user configured preferences. Preferences can include language, dialect, user competency, and the like.

Specialized language tutors 214 can be presented in the contacts list for users of interface 230 to participate in language exercises. Tutors 214 can include localized programmatic software, remote computing service, human agent services, and the like. Tutors 214 can be configured to engage users in language exercises of varying competency levels. Competency levels can include preset degrees of exercise difficulty/complexity, a heuristically determined competency level matching a user's fluency, and the like. Tutors 214 can engage users in practice conversations in a particular language based on tutor selected from contacts 210. For example, selecting a Spanish tutor, Alice can initiate a conversation using the word “hello” 234, which can trigger an appropriate response from the Spanish tutor “hola” 236. In one embodiment, the one or more tutors 214 can be implemented as automated software agents, as opposed to belonging to live human communicators.

As shown in FIG. 2, interface 230 can be used by users to communicate with other users and tutors in one or more different languages. Appropriate language translations can be presented to users in interface 230 as shown in area 238. User input can be dynamically translated and presented in the text area not being edited by the user. For example, as a user inputs “I am fine, thank you” in the top text area, the bottom text area can present the appropriate translation “Estoy bien, gracias”. Interface 230 can include language aids such as phonetic pronunciation 242 and audible pronunciation sound samples 244. Additional language tools 240 can be presented to the user of interface 230. Tools 240 can include, but are not limited to, spelling/grammar checking, language advisor functionality, message log functionality, additional language resources/tools, language specific dictionary, language specific configuration options, and the like.

User sessions can be stored in a message log for review by the user at a later time. Message log (not shown) can include spelling, grammar, and/or punctuation errors made during the session. Further, translations can be presented or removed from the message log based on user configured settings.

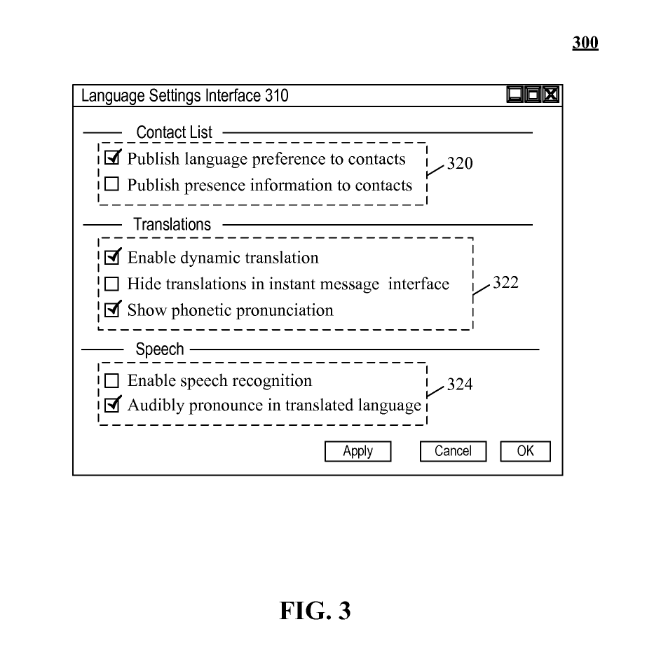

FIG. 3 is a schematic diagram illustrating an interface 300 for configuring language settings of an interface, which can assist a user in learning a language in accordance with an embodiment of the inventive arrangements disclosed herein. Interface 300 can be presented in the context of system 100. Interface 300 can be utilized to configure an instant messaging functionality capable of assisting a user learning a language. Sections 320-324 can include settings to enable/disable language aiding functionality in an instant messaging interface.

In section 320, configuration language options for a contact list can be presented. Options can include preferences for publishing language information, presence information, and the like. User language preference, such as languages the user has an interest in learning, can be published to contacts associated with the user. Further, languages the user has competency/fluency in can be presented to contacts to allow users to establish conversations with users of appropriate competency level. Presence information can be published to contacts to assist in allowing users to establish conversations easily. For example, users on mobile devices can allow their presence information to be available to contacts allowing learning to be performed from any location.

In section 322, translation configuration options for an instant message interface can be presented. Translation options can include, but is not limited to, dynamic translations, enabling/disabling translations, presenting phonetic pronunciation of instant messages, and the like. Dynamic translations, such as translation of user inputted messages as the user types, can be presented to a user interacting with the instant message interface. Dynamic translations can be a resource intensive process and can be configured to perform efficiently on devices with low computing resources, minimizing resource use. Another configurable option can include enabling or disabling translations presented alongside instant messages in the instant message interface. Alternatively, a delay timer for presenting translations can be configured. Language learning can be further facilitated through the enabling/disabling of a phonetic pronunciation of translations.

In section 324, speech recognition and audible voice pronunciations can be enabled to allow interaction of an instant message interface to occur using voice. These options can be automatically enabled when instant messages are presented in a voice user interface (VUI). Enabling speech recognition can allow users to practice spoken pronunciations of a language aiding users in spoken communication. Additionally, audible pronunciations can be presented to the user to assist in learning the appropriate pronunciation.

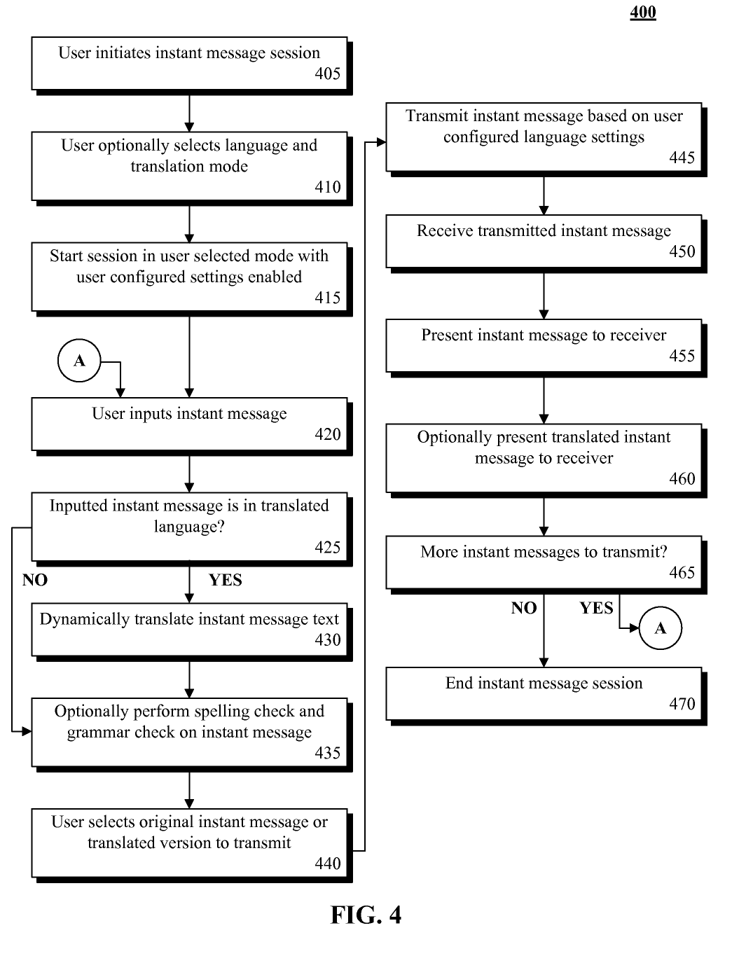

FIG. 4 is a schematic diagram illustrating a method 400 for simultaneously presenting a user with an instant message and a corresponding translation into another language in accordance with an embodiment of the inventive arrangements disclosed herein. Method 400 can be performed in the context of system 100. In method 400, a user interacting with an instant messaging client can be presented with a translation of an inputted instant message to aid in learning a user selected language. Based on user selected options, the user can communicate with another communicator in a native or a foreign language.

In step 405, a user initiates an instant message session through interaction with an instant message client. The instant message client can be a graphical user interface (GUI), a voice user interface (VUI), and the like. In step 410, a user optionally selects a language and a translation mode of the instant message client. Languages can be supported based on language mappings available to the instant message client. Languages can include natural languages, mixed languages, region specific dialects, sign language, constructed languages, and the like. The translation mode can include dynamic translation, translation of messages prior to and/or after transmission, and the like. In step 415, the instant message session can start in a user selected mode and with user configured settings enabled. In step 420, a user inputs an instant message to transmit to another communicator. In step 425, if instant message is in translated language the method can continue to step 430, else proceed to step 435.

In step 430, the user entered instant message is dynamically translated as the user inputs letters, words, and/or sentences. Dynamic translation can be adjusted/scaled to perform effectively on devices with low computing resources. In step 435, a spelling check and/or grammar check can be optionally performed on the instant message based on the language competency level of the user. This check can also be automatically performed or manually invoked by the user based on user configured settings. In step 440, the user selects the original instant message or the translated version to transmit. In step 445, the instant message is transmitted based on user configured language settings. In step 450, the communicator's instant message client receives the transmitted instant message. In step 455, the receiver is presented with the transmitted instant message. In step 460, the receiver can be optionally presented with a translation of the transmitted instant message. In step 465, if there are more instant messages to transmit, the method can return to step 420, else continue to step 470. In step 470, the instant message session can be terminated.

The diagrams in FIGS. 1-4 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for dynamically translating Instant Messaging (IM) communications comprising:
identifying IM content that was entered into an IM interface in a first language;
automatically translating the IM content to a second language; and
presenting within an IM interface the translated IM content in the second language and presenting the identified IM content in the first language.

2. The method of claim 1, wherein the IM interface in which the IM content was entered is an interface of a client remotely located from a client rendering the interface upon which the IM content in the second language is presented.

3. The method of claim 1, wherein the translating occurs in an IM server that facilitates IM communications, the method further comprising:
the IM server conveying IM data to a client rendering the interface upon which the IM content is presented, said conveyed IM data comprising IM content in the first language and IM content in the second language.

4. The method of claim 1, further comprising:
audibly presenting within the IM interface the translated IM content in the second language.

5. The method of claim 1, wherein the interface in which the IM content is entered and the interface in which the IM content is presented is the same interface, said method further comprising:
presenting the translated IM content and the content in the first language before content is conveyed from the IM interface to at least one remotely located IM users, and wherein only the translated content is conveyed to at least one of the remotely located IM users.

6. The method of claim 1, wherein said steps of claim 1 are steps performed automatically by at least one machine in accordance with at least one computer program having a plurality of code sections that are executable by the at least one machine, said at least one computer program being stored in a machine readable medium.

7. An instant messaging (IM) system comprising:
an IM server configured to facilitate IM communications involving a plurality of IM users, said IM server comprising a presence component and a translation service component;
said presence component configured to provide presence information regarding the IM users for presentation in a plurality of contact list of client-side IM applications; and
said translation service component configured to receive IM content in a first language, configured to translate the received IM component to a second language in accordance with recipient established settings, and configured to convey the received IM content in the first language and the translated IM content in the second language to a remotely located client of a recipient associated with the recipient established settings.

8. The system of claim 7, wherein said presence component is further configured to provide a plurality of languages in which associated IM users are registered to communicate in IM communications to other ones of the IM users for presentation in the contact lists of the client-side applications.

9. The system of claim 7, further comprising:
at least one IM application comprising an IM interface, wherein a dialog body of the IM interface presents the IM content in the first language and in the second language even though an original IM application remotely located from said IM application in which the IM content is presented only received user input for the IM content in the first language.

10. The system of claim 7, further comprising:
a set of at least three clients, each having a client-side IM application configured to participate in a communication session facilitated by the IM server, wherein the client-side applications are configured so that the IM content is entered into one of the clients in the first language, wherein another of the IM applications presents the entered IM content in only the first language, and wherein the third of the IM applications presents the entered IM content in the first language and in the second language.

11. The system of claim 7, further comprising:
a server-side repository configured to store IM user settings, which comprise said recipient established settings.

12. The system of claim 7, wherein said IM server is configured to exchange text and at least one of data, audio, and video in real time with the IM users.

13. An instant messaging (IM) interface comprising:
a dialog region configured to present a running IM dialog comprising content exchanged in real-time between a plurality of IM communicators, wherein the dialog region is configured such that at least a portion of the content from IM communicators presented in the dialog region is presented in an original language in which it was entered and is also presented in a translated form in a different language specified by settings specific to the user of the IM interface; and
a communication entry region configured to permit content to be input that is to be conveyed to each of the IM communicators participating in an IM communication session involving the user of the IM interface.

14. The interface of claim 13, wherein said communication entry region further comprises:
a first entry field associated with a first language;
a second entry field associated with a second language, wherein the first entry field and the second entry field are programmatically linked such that content entered in one of the entry fields is dynamically translated and presented in a translated form in the other entry field; and
an entry submission field configured to convey content entered in the communication entry to a remotely located computing device when selected, wherein the conveyed content consists of content in a single language from only one of the first entry field and content from the second entry field.

15. The interface of claim 14, wherein the communication entry region comprises at least one text entry input control and at least one speech entry audio input control, wherein the text entry control is configured to permit text to be entered in the original language or in the different language and wherein the speech entry audio input control is configured to permit audio input spoken in the original language or in the different language to be handled by a speech processing component programmatically linked to the speech entry audio input control.

16. The interface of claim 13, further comprising:
a contact list configured to present a plurality of identifiers for a plurality of associated IM communicators and their status regarding IM communications, wherein said contact list is further configured to present an indicator of a plurality of languages with which at least one of the IM communicators is able to communicate.

17. The interface of claim 16, wherein the contact list further comprises a plurality of categories, wherein each category comprises a plurality of the identifiers for IM communicators having characteristics associated with that category, wherein a plurality of the categories represent different languages, which the associated IM communicators are able to communicate.

18. The interface of claim 13, wherein said interface is a speech enabled interface programmatically linked to a speech processing engine.

19. The interface of claim 13, wherein said interface is a multimodal interfacing configured to selectively present the IM content in the translated form in an audible format in which the translated form of the IM content is spoken and in a textual format in which the translated form of the IM content is presented in a written form in the second language.

20. The interface of claim 13, further comprising:
a configuration interface configured to permit a user of the interface to specify a plurality of languages with which the user is able to participate in IM communications, wherein said user specified languages are published to other ones of the IM communicators.
